(19) United States
(12) Patent Application Publication
(10) Pub. No.: US 2023/0038583 A1
(43) Pub. Date: Feb. 9, 2023

(54) HETEROPHASIC PROPYLENE COPOLYMER COMPOSITION

(71) Applicant: SABIC GLOBAL TECHNOLOGIES B.V., BERGENOPZOOM (NL)

(72) Inventors: Dimphna Johanna Maria van Beek, Sittard (NL); Christelle Marie Hélène Grein, Aachen (DE); Gerard Jan Eduard Biemond, Brunssum (NL); Zahra Fahimi, Maastricht (NL)

(21) Appl. No.: 17/786,777

(22) PCT Filed: Dec. 18, 2020
(86) PCT No.: PCT/EP2020/087084

§ 371 Date: Jun. 17, 2022

(30) Foreign Application Priority Data
Dec. 24, 2019 (EP) 19219579.0

(51) Int. Cl. C08L 23/16; C08L 23/06; C08L 23/08; C08L 23/12

(52) U.S. Cl. CPC C08L 23/16; C08L 23/06; C08L 23/0815; C08L 23/12; C08L 2207/02; C08L 2207/062; C08L 2205/025; C08L 2205/035; C08L 2203/30

(57) ABSTRACT

The present invention relates to a polymer composition comprising a first heterophasic propylene copolymer, a high density polyethylene, a second heterophasic propylene copolymer an inorganic filler and optionally a polyolefin based elastomer. The present invention further relates to a process for the preparation of said polymer composition. The present invention further relates to an article comprising such polymer composition. The polymer composition has high impact resistance and a good balance between impact resistance and warpage.

### CROSS REFERENCE TO RELATED APPLICATIONS

This application is a National Stage application of PCT/EP2020/087084, filed Dec. 18, 2020, which claims the benefit of European Application No. 19219579.0, filed Dec. 24, 2019, both of which are incorporated by reference in their entirety herein.

### FIELD

The present invention relates to a polymer composition, a process for the preparation of said polymer composition, and an article comprising said polymer composition.

### BACKGROUND

Polymer compositions, especially polymer compositions based on polypropylene are widely used in automotive industry thanks to their excellent mechanical and chemical properties. For automotive applications, it is preferred that such polymer compositions have a high impact resistance so that automotive parts made from such polymer compositions have high toughness. It is known that the addition of a high density polyethylene in a polymer composition based on polypropylene increases the impact resistance of the polymer composition, for example:

WO1998031744A1 discloses an impact polypropylene composition, comprising: an isotactic polypropylene, an ethylene-propylene rubber; a high density polyethylene and an ethylene-propylene copolymer. The impact polypropylene composition has a high impact resistance and stiffness.

CN102627806B discloses a polypropylene/high density polyethylene based plastic with improved toughness.

U.S. Pat. No. 3,256,367A discloses a propylene composition comprising a solid polypropylene, a polyethylene having a density of at least about 0.91 g/cm3 and an amorphous ethylene/propylene copolymer. The propylene composition has a high impact strength.

### SUMMARY

Automotive exterior parts are usually large, for example the length of an automotive exterior part can be longer than 1.21 m, for such large parts even a small percentage of warpage gives a high deviation of the specified dimensions in the overall part. Such deviation may make it impossible to fit the part into a car. For this reason, it is preferred that the polymer composition used in automotive exterior part has a low warpage.

Hence it is the object of the present invention to provide a polymer composition that combines a high impact resistance with a good balance between impact resistance and warpage.

It was found that the object of the present invention is achieved by a polymer composition comprising a first heterophasic propylene copolymer, a high density polyethylene, a second heterophasic propylene copolymer, an inorganic filler and optionally a polyolefin based elastomer,

wherein the MFI of the polymer composition is in the range from 5 to 100 dg/min as measure according to ISO1133-1:2011 with a 2.16 kg load at 230° C.,
wherein the amount of the first heterophasic propylene copolymer is in the range from 9.6 to 70.4 wt % based on the total amount of the polymer composition, wherein the melt flow index (MFI) of the first heterophasic propylene copolymer is in the range from 29 to 103 dg/min as measured according to ISO1133-1:2011 with a 2.16 kg load at 230° C., wherein the xylene soluble part of the first heterophasic propylene copolymer is in the range from 12.9 to 27.8 wt % based on the total amount of the first heterophasic propylene copolymer as measured according to ISO16152:2005, wherein the intrinsic viscosity of the xylene soluble part of the first heterophasic propylene copolymer is in the range from 1.53 to 1.89 dl/g as measured according to ISO1628-3:2010,
wherein the amount of the high density polypropylene is in the range from 0.7 to 10.4 wt % based on the total amount of the polymer composition,
wherein the amount of the second heterophasic propylene copolymer is in the range from 12.3 to 62.5 wt % based on the total amount of the polymer composition wherein the MFI of the second heterophasic propylene copolymer is in the range from 9.3 to 89.3 dg/min as measured according to ISO1133-1:2011 with a 2.16 kg load at 230° C.,
wherein the amount of inorganic filler is in the range from 2.5 to 31.0 wt % based on the total amount of the polymer composition.

### DETAILED DESCRIPTION

It was surprisingly found that the polymer composition according to the present invention has a high impact resistance and shows an excellent balance between impact resistance and warpage.

For avoidance of any confusion, “high impact resistance” means that the impact resistance of the polymer composition according to the present invention is at least 20.1 KJ/m2, preferably at least 24.8 KJ/m2 as measured according to ISO180:2000 at 23° C.; “excellent balance between impact resistance and warpage” means the ratio between the impact resistance and the warpage of polymer composition is at least 2000 KJ/m2, wherein the warpage is measured according to ISO294-4:2018 at 23° C. and wherein the impact resistance is measured according to ISO180:2000 at 23° C.

The First Heterophasic Propylene Copolymer

A heterophasic propylene copolymer typically has a two-phase structure; it comprises a propylene-based semi-crystalline polymer as matrix and a dispersed elastomer phase, usually an ethylene-α-olefin rubber. Heterophasic propylene copolymers are usually prepared in one polymerization process.

The first heterophasic propylene copolymer preferably comprises a first propylene polymer as matrix and a first ethylene-α-olefin copolymer as dispersed phase wherein the moiety of α-olefin in the ethylene-α-olefin copolymer is derived from at least one α-olefin having 3 to 20 carbon atoms, for example the first ethylene-α-olefin copolymer can be an ethylene-propylene copolymer, for example the first ethylene-α-olefin copolymer can be an ethylene-butene copolymer, for example the first ethylene-α-olefin copolymer can be an ethylene-hexene copolymer, for example the first ethylene-α-olefin copolymer can be an ethylene-octene copolymer, for example the first ethylene-α-olefin copolymer can be an ethylene-propylene-butene copolymer, for example the first ethylene-α-olefin copolymer can be an ethylene-propylene-hexene copolymer.

In the first ethylene-α-olefin copolymer, the amount of the moiety derived from ethylene is preferably in the range from 40 to 52 wt %, preferably from 45 to 50 wt % based on the total amount of the ethylene-α-olefin copolymer. Preferably the first ethylene-α-olefin copolymer is an ethylene-propylene copolymer.

The first propylene polymer in the first heterophasic propylene copolymer can be a propylene homopolymer or/and an ethylene-propylene copolymer wherein the amount of the moiety derived from ethylene is in the range from 0.3 to 3.9 wt % based on the total amount of the ethylene-propylene copolymer. Preferably the first propylene polymer in the first heterophasic propylene copolymer is a propylene homopolymer as this will increase the stiffness of the composition of the invention.

The amount of the first propylene polymer is preferably in the range from 65 to 85 wt %, preferably from 70 to 80 wt %, more preferably from 73 to 78 wt % based on the total amount of the first heterophasic propylene copolymer.

The amount of the first ethylene-α-olefin copolymer is preferably in the range from 15 to 35 wt %, preferably from 20 to 30 wt %, more preferably from 22 to 27 wt % based on the total amount of the first heterophasic propylene copolymer.

Preferably, the sum of the first propylene polymer and the first ethylene-α-olefin copolymer is 100 wt % based on the first heterophasic propylene copolymer.

The first heterophasic propylene copolymer can be divided into a first xylene-soluble portion and a first xylene-insoluble portion. The amount of the first xylene-soluble portion is in the range from 12.9 to 27.8 wt %, preferably in the range from 14.3 to 24.8 wt %, more preferably in the range from 18.9 to 22.6 wt % based on the total amount of the first heterophasic propylene copolymer as determined according to ISO16152:2005. The amount of the first xylene-insoluble portion based on the total amount of the first heterophasic propylene copolymer can be calculated by the following equation:

First CXI=100 wt %−First CXS

The intrinsic viscosity of the first xylene-soluble portion is in the range from 1.53 to 1.89 dl/g, preferably in the range from 1.68 to 1.87 dl/g as measured according to ISO1628-1:2009.

The intrinsic viscosity of the first xylene-soluble portion is preferably in the range from 0.91 to 1.56 dl/g, more preferably in the range from 1.12 to 1.34 dl/g, more preferably in the range from 1.20 to 1.29 dl/g as measured according to ISO1628-3:2010.

The term “Visbreaking” is well known techniques in the field of the invention, for example methods of visbreaking polypropylene have been disclosed in U.S. Pat. No. 4,282,076 and EP0063654.

To avoid confusion, in the context of the present invention, “Visbreaking”, “Controlled rheology” and “Shifting” or “Peroxide-shifting” refer to the same process; “Visbroken”, “Produced with controlled rheology”, “Shifted” or “Peroxide-shifted” as adjectives are used to indicate a heterophasic propylene copolymer is prepared by such process.

The first heterophasic propylene copolymer is preferably visbroken.

Several different types of chemical reactions which are well known can be employed for visbreaking propylene based polymers. An example is thermal pyrolysis, which is accomplished by exposing a propylene based polymer to high temperatures, e.g., in an extruder at 350° C. or higher. Another approach is exposure of a propylene based polymer to powerful oxidizing agents. A further approach is exposure to ionizing radiation. It is preferred however that visbreaking is carried out using a peroxide, that is the reason “Shifting” is often referred as “Peroxide-shifting” in literatures. Such materials, at elevated temperatures, initiate a free radical chain reaction resulting in beta-scission of the propylene based polymer molecules. The visbreaking may be carried out directly after polymerisation and removal of unreacted monomer and before pelletisation (during extrusion in an extruder wherein shifting of the propylene based polymer occurs). However, the invention is not limited to such an embodiment and visbreaking may also be carried out on already pelletised propylene based polymers generally contains stabilisers to prevent degradation.

Examples of suitable peroxides include organic peroxides having a decomposition half-life of less than 1 minute at the average process temperature during extrusion. Suitable organic peroxides include but are not limited to dialkyl peroxides, e.g. dicumyl peroxides, peroxyketals, peroxycarbonates, diacyl peroxides, peroxyesters and peroxydicarbonates. Specific examples of these include benzoyl peroxide, dichlorobenzoyi peroxide, dicumyl peroxide, di-tert-butyl peroxide, 2,5-dimethyl-2,5-di(peroxybenzoato)-3-hexene, 1,4-bis(tert-butylperoxyisopropyl)benzene, lauroyl peroxide, tert-butyl peracetate, a,a′-bis(tert-butylperoxy)diisopropylbenzene (Luperco® 802), 2,5-dimethyl-2,5-di(tert-butylperoxy)-3-hexene, 2,5-dimethyl-2,5-di(tert-butylperoxy)-hexane, tert-butyl perbenzoate, tert-butyl perphenylacetate, tert-butyl per-sec-octoate, tert-butyl perpivalate, cumyl perpivalate, cumene hydroperoxide, diisopropyl benzene hydroperoxide, 1,3-bis(t-butylperoxy-isopropyl)benzene, dicumyl peroxide, tert-butylperoxy isopropyl carbonate and any combination thereof. Preferably, a dialkyl peroxides is employed in the process according to the present invention. More preferably, the peroxide is a,a′-bis-(tert-butylperoxy)diisopropylbenzene, 2,5-dimethyl-2,5-di(tert-butylperoxy)-hexane or 3,6,9-Triethyl-3,6,9-trimethyl-1,4,7-triperoxonane. Preferably, the peroxide is selected from the group of non-aromatic peroxides.

It can easily be determined by the person skilled in the art through routine experimentation how much peroxide should be used to obtain a composition having the desired melt flow rate. This also depends on the half-life of the peroxide and on the conditions used for the melt-mixing, which in turn depend on the exact composition.

In a heterophasic propylene copolymer, during the visbreaking process, the type and the amount of comonomer in the dispersed phase and in the matrix of a propylene based polymer do not vary; the amount of the dispersed phase and of the matrix of the heterophasic propylene copolymer also do not vary.

In one embodiment, the amount of peroxide used to shift the first heterophasic propylene copolymer is for example in the range from 0.01 to 0.5 wt %, for example from 0.08 to 0.2 wt %, for example from 0.1 to 0.2 wt % based on the total amount of the first heterophasic propylene copolymer.

The MFI of the first heterophasic propylene copolymer is in the range from 29 to 103 dg/min, preferably from 41 to 92 dg/min, more preferably from 45 to 83 dg/min as measured according to ISO1133-1:2011 with a 2.16 kg load at 230° C.

Before shifting, the MFI of the first heterophasic propylene copolymer is preferably in the range from 4.9 to 19.8 dg/10 min, preferably from 7.8 to 16.0 dg/min, more preferably from 10.2 to 14.3 dg/10 min as measured according to ISO1133-1:2011 with a 2.16 kg load at 230° C.

The first heterophasic propylene copolymers can be produced in a process comprising a polymerization step, for example, a multistage polymerization, such as bulk polymerization, gas phase polymerization, slurry polymerization, solution polymerization or any combinations thereof. Any conventional catalyst systems, for example, Ziegler-Natta or metallocene may be used. Such polymerization steps and catalysts are described, for example, in WO06/010414; Polypropylene and other Polyolefins, by Ser van der Ven, Studies in Polymer Science 7, Elsevier 1990; WO06/010414, U.S. Pat. Nos. 4,399,054 and 4,472,524. Preferably, the first heterophasic propylene copolymer is made using Ziegler-Natta catalyst.

The heterophasic propylene copolymer may be prepared by a process comprising a polymerization step comprising
polymerizing propylene and optionally ethylene and/or α-olefin in the presence of a catalyst system to obtain the propylene-based matrix and
subsequently polymerizing ethylene with α-olefins in the presence of a catalyst system in the propylene-based matrix to obtain the heterophasic propylene copolymer consisting of a propylene-based matrix and a dispersed phase. These steps are preferably performed in different reactors. The catalyst systems for the first step and for the second step may be different or same.

Catalysts that are suitable for use in the preparation of the first heterophasic propylene copolymer are also know in the art. Examples include Ziegler-Natta catalysts and metallocene catalysts. Preferably the catalyst used to produce the first heterophasic propylene copolymer is free of phthalate, for example the catalyst comprises compounds of a transition metal of Group 4 to 6 of IUPAC, a Group 2 metal compound and an internal donor wherein said internal donor include but are not limited to 1,3-diethers, for example 9,9-bis (methoxymethyl) fluorene, optionally substituted malonates, maleates, succinates, glutarates, benzoic acid esters, cyclohexene-1,2-dicarboxylates, benzoates, citraconates, aminobenzoates, silyl esters and derivatives and/or mixtures thereof.

For example the catalyst used in the preparation of the first heterophasic propylene copolymer is a Ziegler-Natta catalyst comprising a procatalyst, at least one external donor, a co-catalyst and an optional internal donor wherein the external electron donor is chosen from the group consisting of a compound having a structure according to Formula III (R⁹⁰)₂N—Si(OR⁹¹)₃, a compound having a structure according to Formula IV: (R⁹²)Si(OR⁹³)₃ and mixtures thereof, wherein each of R⁹⁰, R⁹¹, R⁹² and R⁹³ groups are each independently a linear, branched or cyclic, substituted or unsubstituted alkyl having between 1 and 10 carbon atoms, preferably a linear unsubstituted alkyl having between 1 and 8 carbon atoms, preferably ethyl, methyl or n-propyl.

In one embodiment, R⁹⁰ and R⁹¹ are each ethyl (compound of Formula III is diethylaminotriethoxysilane, DEATES). In another embodiment, R⁹² is n-propyl and R⁹³ are each ethyl (compound of Formula IV is n-propyl triethoxysilane, nPTES) or in another embodiment R⁹² is n-propyl and R⁹³ are each methyl (compound of Formula IV is n-propyl trimethoxysilane, nPTMS),

Preferably, the heterophasic propylene copolymer of the invention is prepared according to the process for the manufacture of the heterophasic propylene copolymer, wherein step I) is performed in the presence of a catalyst system comprising a Ziegler-Natta catalyst and at least one electron donor chosen from the group of nPTES, nPTMS, DEATES and mixtures thereof.

Preferably, the heterophasic propylene copolymer of the invention is prepared by a catalyst system comprising a Ziegler-Natta catalyst and at least one external electron donor chosen from the group of a compound having a structure according to Formula III (R⁹⁰)₂N—Si(OR⁹¹)₃, a compound having a structure according to Formula IV: (R⁹²)Si(OR⁹³)₃ and mixtures thereof.

A “co-catalyst” is a term well-known in the art in the field of Ziegler-Natta catalysts and is recognized to be a substance capable of converting the procatalyst to an active polymerization catalyst. Generally, the co-catalyst is an organometallic compound containing a metal from group 1, 2, 12 or 13 of the Periodic System of the Elements (Handbook of Chemistry and Physics, 70th Edition, CRC Press, 1989-1990). The co-catalyst may include any compounds known in the art to be used as “co-catalysts”, such as hydrides, alkyls, or aryls of aluminum, lithium, zinc, tin, cadmium, beryllium, magnesium, and combinations thereof. The co-catalyst may be a hydrocarbyl aluminum co-catalyst, such as triisobutylaluminum, trihexylaluminum, diisobutylaluminum hydride, dihexylaluminum hydride, isobutylaluminum dihydride, hexylaluminum dihydride, diisobutylhexylaluminum, isobutyl dihexylaluminum, trimethylaluminum, triethylaluminum, tripropylaluminum, triisopropylaluminum, tri-n-butylaluminum, trioctylaluminum, tridecylaluminum, tridodecylaluminum, tribenzylaluminum, triphenylaluminum, trinaphthylaluminum, and tritolylaluminum. In an embodiment, the cocatalyst is selected from triethylaluminum, triisobutylaluminum, trihexylaluminum, diisobutylaluminum hydride and dihexylaluminum hydride. More preferably, trimethylaluminium, triethylaluminium, triisobutylaluminium, and/or trioctylaluminium. Most preferably, triethylaluminium (abbreviated as TEAL). The co-catalyst can also be a hydrocarbyl aluminum compound such as tetraethyl-dialuminoxane, methylaluminoxane, isobutylaluminoxane, tetraisobutyl-dialuminoxane, diethyl-aluminumethoxide, diisobutylaluminum chloride, methylaluminum dichloride, diethylaluminum chloride, ethylaluminum dichloride and dimethylaluminum chloride, preferably TEAL.

For example, the procatalyst may be prepared by a process comprising the steps of providing a magnesium-based support, contacting said magnesium-based support with a Ziegler-Natta type catalytic species, an internal donor, and an activator, to yield the procatalyst. For example, the Examples of U.S. Pat. No. 5,093,415 of Dow discloses an improved process to prepare a procatalyst. Preferably, the procatalyst is a chemical compound comprising titanium.

In the context of the present invention, the molar ratio between Si and Ti element in the catalyst system is preferably in the range from 0.1 to 40, preferably from 0.1 to 20, even more preferably from 1 to 20 and most preferably from 2 to 10. Preferably the molar ratio between Al and Ti element in the catalyst system is in the range from 5 to 500, preferably from 15 to 200, more preferably from 30 to 160, most preferably from 50 to 140.

In one embodiment, the molar ratio between Si and Ti element is the molar ratio between the external donor and the procatalyst.

In one embodiment, the molar ratio between Al and Ti element is the molar ratio between the co-catalyst and the procatalyst.

High Density Polyethylene

A high density polyethylene is a polyethylene of a linear structure.

The high density polyethylene according to the present invention may comprise one or more comonomers, wherein the comonomer is moiety derived from 1-butene or/and 1-hexene, wherein the amount of comonomer is preferably at most 1.2 wt %, preferably at most 1.0 wt %, preferably at most 0.7 wt %, preferably at most 0.5 wt %, preferably at most 0.3 wt % based on the total amount of the high density polyethylene.

The MFI of the high density polyethylene according to the present invention is preferably in the range from 2.3 to 19.8 dg/min, preferably from 4.9 to 15.4 dg/min, more preferably from 6.1 to 11.5 dg/min as measured according to ASTM D1238-13 with a 2.16 kg load at 190° C.

The density of the high density polyethylene according to the present invention is preferably in the range from 0.920 to 0.972 g/cm³, preferably from 0.953 to 0.970 g/cm³, more preferably from 0.960 to 0.968 g/cm³ as measured according to ASTM D792-13.

The high density polyethylene according to the present invention can for example have a unimodal molecular weight distribution or a multimodal molecular weight distribution, for example a bimodal molecular weight distribution.

The production processes of the high density polyethylene and is summarized in “Handbook of Polyethylene” by Andrew Peacock (2000; Dekker; ISBN 0824795466) at pages 43-66. Suitable catalysts for the production of polyethylene include Ziegler Natta catalysts, chromium based catalysts and single site metallocene catalysts.

The unimodal polyethylene may be obtained for example by polymerizing ethylene and optionally at least one olefin comonomer in slurry in the presence of a silica-supported chromium-containing catalyst and/or an alkyl boron compound. Suitable comonomers include for example 1-butene and 1-hexene. The unimodal polyethylene may be obtained for example by polymerizing ethylene and optionally at least one olefin comonomer in a gas phase polymerisation or in slurry polymerisation process.

The production processes for bimodal high density polyethylene are summarized at pages 16-20 of “PE 100 Pipe systems” (edited by Bromstrup; second edition, ISBN 3-8027-2728-2). The production of bimodal high density polyethylene via a low pressure slurry process is described by Alt et al. in “Bimodal polyethylene-Interplay of catalyst and process” (Macromol. Symp. 2001, 163, 135-143). The characteristics of the polyethylene are determined amongst others by the catalyst system and by the concentrations of catalyst, comonomer and hydrogen. The production of bimodal high density polyethylene via a low pressure slurry process may also be performed via a three stage process. The concept of the two stage cascade process is elucidated at pages 137-138 by Alt et al. “Bimodal polyethylene-Interplay of catalyst and process” (Macromol. Symp. 2001, 163).

Preferably the high density polyethylene according to the present invention has a unimodal molecular weight distribution.

Optional Polyolefin Based Elastomer

Optionally the polymer composition according to the present invention comprises a polyolefin based elastomer. The polyolefin based elastomer is preferably an ethylene-α-olefin copolymer wherein the α-olefin has 3 to 20 carbon atoms, for example the ethylene-α-olefin copolymer is an ethylene-propylene copolymer, for example the ethylene-α-olefin copolymer is an ethylene-butene copolymer, for example the ethylene-α-olefin copolymer is an ethylene-hexene copolymer, for example the ethylene-α-olefin copolymer is an ethylene-octene copolymer or a combination thereof.

Preferably the polyolefin based elastomer is an ethylene-butene copolymer or/and an ethylene-octene copolymer.

Preferably the amount of moiety derived from ethylene in the polyolefin based elastomer is in the range from 45 to 90 wt %, preferably from 50 to 87 wt %, more preferably from 55 to 85 wt %, more preferably from 57 to 70 wt % based on the total amount of the polyolefin based elastomer.

The polyolefin based elastomer according to the present invention preferably has a shore A hardness in the range from 44 to 101, preferably from 48 to 92, more preferably from 51 to 79, more preferably from 54 to 68 as measured according to ASTM D2240-15.

The density of the polyolefin based elastomer according to the present invention is preferably in the range from 0.853 to 0.905 g/cm³, preferably from 0.859 to 0.896 g/cm³, more preferably from 0.860 to 0.882 g/cm³, more preferably from 0.860 to 0.876 g/cm³ as measured according to ASTM D792-13.

The MFI of the polyolefin based elastomer is preferably in the range from 0.2 to 20.0 dg/min, preferably in the range from 0.3 to 14.3 dg/min, more preferably in the range from 0.4 to 7.2 dg/min as measured according to ASTM D1238-13 with a 2.16 kg load at 190° C.

The polyolefin based elastomer may be prepared using methods known in the art, for example by using a single site catalyst, i.e., a catalyst the transition metal components of which is an organometallic compound and at least one ligand of which has a cyclopentadienyl anion structure through which such ligand bondingly coordinates to the transition metal cation. This type of catalyst is also known as “metallocene” catalyst. Metallocene catalysts are for example described in U.S. Pat. Nos. 5,017,714 and 5,324,820. The polyolefin based elastomer may also be prepared using traditional types of heterogeneous multi-sited Ziegler-Natta catalysts.

Second Heterophasic Propylene Copolymer

The polymer composition according to the present invention further comprises a second heterophasic propylene copolymer.

The second heterophasic propylene copolymer according to the present invention preferably comprises a second propylene polymer as matrix and a second ethylene-α-olefin copolymer as dispersed phase wherein the moiety of α-olefin in the second ethylene-α-olefin copolymer is derived from at least one α-olefin having 3 to 20 carbon atoms, for example the second ethylene-α-olefin copolymer can be an ethylene-propylene copolymer, for example the second ethylene-α-olefin copolymer can be an ethylene-butene copolymer, for example the second ethylene-α-olefin copolymer can be an ethylene-hexene copolymer, for example the second ethylene-α-olefin copolymer can be an ethylene-octene copolymer, for example the second ethylene-α-olefin copolymer can be an ethylene-propylene-butene copolymer, for example the second ethylene-α-olefin copolymer can be an ethylene-propylene-hexene copolymer.

In the second ethylene-α-olefin copolymer, the amount of the moiety derived from ethylene is preferably in the range from 35 to 67 wt %, preferably in the range from 37 to 64 wt %, more preferably in the range from 41 to 62 wt % based on the total amount of the second ethylene-α-olefin copolymer. Preferably the second ethylene-α-olefin copolymer is an ethylene-propylene copolymer.

The second propylene polymer in the second heterophasic propylene copolymer can be a propylene homopolymer or/and an ethylene-propylene copolymer wherein the amount of the moiety derived from ethylene is in the range from 0.3 to 3.9 wt % based on the total amount of the ethylene-propylene copolymer. Preferably the second propylene polymer in the second heterophasic propylene copolymer is a propylene homopolymer thanks to its high stiffness.

The amount of the second ethylene-α-olefin copolymer is preferably in the range from 12 to 29 wt %, preferably from 15 to 28 wt % based on the total amount of the second heterophasic propylene copolymer.

The second heterophasic propylene copolymer can be divided into a second xylene-soluble portion and a second xylene-insoluble portion. The amount of the second xylene-soluble portion is in the range from 9.8 to 25.4 wt %, preferably from 11.2 to 23.3 wt %, more preferably from 12.6 to 22.2 wt % based on the total amount of the second heterophasic propylene copolymer as determined according to ISO16152:2005. The amount of the second xylene-insoluble portion based on the total amount of the second heterophasic propylene copolymer can be calculated by the following equation:

Second CXI=100 wt %−Second CXS

The intrinsic viscosity of the second xylene-soluble portion is preferably in the range from 1.92 to 5.60 dl/g, preferably from a 2.16 to 4.87 dl/g, more preferably from 2.19 to 4.54 dl/g as measured according to ISO1628-1:2009.

The intrinsic viscosity of the second xylene-insoluble portion is preferably in the range from 0.85 to 1.60 dl/g, more preferably in the range from 0.97 to 1.55 dl/g, more preferably in the range from 1.09 to 1.50 dl/g, more preferably from 1.15 to 1.45 dl/g as measured according to ISO1628-3:2010.

The MFI of the second heterophasic propylene copolymer is in the range from 9.3 to 89.3 dg/min, preferably in the range from 10.3 to 55.2 dg/min, more preferably in the range from 11.7 to 48.2 dg/min as measured according to ISO1133-1:2011 with a 2.16 kg load at 230° C.

Inorganic Filler

The polymer composition according to the present invention further comprises an inorganic filler.

Suitable examples of inorganic fillers include but are not limited to talc, calcium carbonate, wollastonite, barium sulfate, kaolin, glass flakes, laminar silicates (bentonite, montmorillonite, smectite) and mica.

For example, the inorganic filler is chosen from the group of talc, calcium carbonate, wollastonite, mica and mixtures thereof.

More preferably, the inorganic filler is talc. The mean particle size of talc (D50) of talc is preferably in the range from 0.1 to 10.2 micron, preferably from 0.3 to 8.1 micron, more preferably from 0.5 to 5.2 micron, even more preferably from 0.6 to 2.5 micron according to sedimentation analysis, Stockes' law (ISO 13317-3:2001).

Optional Additives

The polymer composition according to the present invention may further contain additives, for instance nucleating agents and clarifiers, stabilizers, release agents, plasticizers, anti-oxidants, lubricants, antistatics, cross linking agents, scratch resistance agents, high performance fillers, pigments and/or colorants, flame retardants, blowing agents, acid scavengers, recycling additives, anti-microbials, anti-fogging additives, slip additives, anti-blocking additives, polymer processing aids and the like. Such additives are well known in the art. The amount of the additives is preferably to be at most 5.0 wt %, preferably at most 4.5 wt %, preferably at most 4 wt %, more preferably at most 3.8 wt % based on the total amount of the polymer composition. The reason for the preference of the low amount of additives is that at this amount, additives do not have negative influence on the desired properties of the polymer composition according to the present invention.

In a preferred embodiment, the polymer composition comprises a low amount or essentially free of coupling agent, wherein the amount of the coupling agent is preferably at most 0.46 wt %, preferably at most 0.40 wt %, more preferably at most 0.36 wt %, more preferably at most 0.31 wt % based on the total amount of the polymer composition, wherein the coupling agent is a maleic anhydride grafted polypropylene. For instance, the maleic anhydride grafted polypropylene can be Exxelor™ PO 1020 commercially available from ExxonMobil. The reason for the preference of the low amount of the coupling agent is that the combination of the inorganic filler and a high amount of the coupling agent potentially leads to a deterioration of the impact resistance of the polymer composition according to the present invention.

Polymer Composition

The amount of the first heterophasic propylene copolymer in the polymer composition is in the range from 9.6 to 66.5 wt %, preferably from 12.3 to 66.5 wt %, more preferably from 13.4 to 60.2 wt % based on the total amount of the polymer composition.

The amount of the high density polyethylene in the polymer composition is in the range from 0.7 to 10.4 wt %, preferably from 1.3 to 9.1 wt %, more preferably from 2.0 to 8.5 wt %, more preferably from 2.4 to 7.7 wt % based on the total amount of the polymer composition.

The amount of the second polymer composition is in the range from 12.3 to 62.5 wt %, preferably from 13.5 to 57.2 wt %, more preferably from 14.2 to 56.3 wt % based on the total amount of the polymer composition.

The amount of the optional polyolefin based elastomer in the polymer composition is preferably in the range from 0.5 to 18.7 wt %, more preferably from 2.3 to 15.6 wt %, more preferably from 4.0 to 12.6 wt %, more preferably from 4.6 to 10.5 wt % based on the total amount of the polymer composition.

The amount of the inorganic filler is in the range from 2.5 to 31.0 wt %, preferably from 3.4 to 25.6 wt %, more preferably from 4.6 to 20.7 wt %, more preferably from 5.7 to 17.3 wt % based on the total amount of the polymer composition.

The total amount of the first heterophasic propylene copolymer and the high density polyethylene is preferably in the range from 19.5 to 71.0 wt %, preferably from 25.1 to 60.2 wt % based on the total amount of the polymer composition.

The total amount of the first heterophasic propylene copolymer, the high density polyethylene, the second heterophasic propylene copolymer, the optional polyolefin based elastomer, the optional inorganic filler and the optional additives is at least 95 wt %, preferably at least 97 wt %, preferably at least 98.5 wt % and preferably at most 100 wt % based on the total amount of the polymer composition.

The MFI of the polymer composition is in the range from 5 to 100 dg/min, preferably from 10 to 70 dg/min, more preferably from 15 to 50 dg/min as measure according to ISO1133-1:2011 with a 2.16 kg load at 230° C. as in the preferred MFI range, the polymer composition has an optimal balance between impact performance and processability.

The polymer composition according to the present invention can for example be prepared in an extrusion process by melt-mixing the first heterophasic propylene copolymer, the high density polyethylene, the second heterophasic propylene copolymer, the optional polyolefin elastomer, the inorganic filler and the optional additives in an extruder.

The present invention further relates to a process for the preparation of an article, preferably an automotive part, comprising the sequential steps of:
Providing the polymer composition according to the present invention;
Shaping the polymer composition according to the present invention into the article, preferably by injection molding.

The present invention further relates to the use of the polymer composition according to the present invention in the preparation of an article, preferably an automotive part, for example an automotive interior part, for example an automotive exterior part.

The present invention further relates to an article, preferably injection molded article, more preferably injection molded automotive article obtained or obtainable by the process of the present invention, wherein the amount of the polymer composition according to the present invention is at least 95 wt %, preferably at least 98 wt % based on the total amount of the article.

For the avoidance of any confusion, in the context of the present invention, the term “amount” can be understood as “weight”; “Melt flow index (MFI)” refers to the same physical property as “melt flow rate (MFR)”.

It is noted that the invention relates to all possible combinations of features described herein, preferred in particular are those combinations of features that are present in the claims. It will therefore be appreciated that all combinations of features relating to the composition according to the invention; all combinations of features relating to the process according to the invention and all combinations of features relating to the composition according to the invention and features relating to the process according to the invention are described herein.

It is further noted that the term ‘comprising’ does not exclude the presence of other elements. However, it is also to be understood that a description on a product/composition comprising certain components also discloses a product/composition consisting of these components. The product/composition consisting of these components may be advantageous in that it offers a simpler, more economical process for the preparation of the product/composition. Similarly, it is also to be understood that a description on a process comprising certain steps also discloses a process consisting of these steps. The process consisting of these steps may be advantageous in that it offers a simpler, more economical process. When values are mentioned for a lower limit and an upper limit for a parameter, ranges made by the combinations of the values of the lower limit and the values of the upper limit are also understood to be disclosed.

The invention is now elucidated by way of the following examples, without however being limited thereto.

### EXPERIMENTAL

Material

Polymer A, B and C are heterophasic propylene copolymers prepared in an Innovene™ process, wherein a sequential two-reactor setup was employed. Polypropylene homopolymers were produced in first reactor and propylene-ethylene copolymers were produced in the second reactor.

There were three component in the catalyst system in the polymerization process: A procatalyst, an external electron donor and a co-catalyst. The procatalyst was prepared according to the description in WO2016198344, page 36, “Procatalyst III” paragraph; The external electron donor used for Polymer A and B was di(iso-propyl) dimethoxysilane (DiPDMS), the external electron donor used for Polymer C and D was n-propyltriethoxysilane (nPTES); the co-catalyst was triethylaluminium.

The process condition of Polymer A, B and C are given in Table 1:

TABLE 1
Preparation condition of Polymer A, B and C

| | Polymer | | |
|---|---|---|---|
| | A | B | C |
| R1 Te (° C.) | 66 | 66 | 69.5 |
| R1 Pr (Bar) | 24 | 24 | 24 |
| Al/Ti (mol/mol) | 135 | 135 | 135 |
| Si/Ti (mol/mol) | 10 | 10 | 10 |
| R1 H2/C3 (mol/mol) | 0.08 | 0.05 | 0.01 |
| R1 split (wt %) | 80 | 74 | 76 |
| R2 Te (° C.) | 66 | 57 | 66 |
| R2 Pr (Bar) | 24 | 24 | 24 |
| R2 H2/C3 (mol/mol) | 0.132 | 0.005 | 0.011 |
| R2 C2/C3 (mol/mol) | 0.63 | 0.33 | 0.3 |
| R2 split (wt %) | 20 | 26 | 24 |

In Table 1, R1 refers to the first reactor, R2 refers to the second reactor, Te refers to temperature, Pr refers to pressure, Al/Ti is the molar ratio of the co-catalyst to the procatalyst, Si/Ti is the molar ratio of the external donor to the procatalyst, H2/C3 is the molar ratio of hydrogen to propylene, C2/C3 is the molar ratio of ethylene to propylene, split is the amount of substance produced in R1 or R2 based on the amount of the total Polymer A or B or C respectively.

HDPE 80064 is an HDPE commercially available from SABIC with grade name HDPE M80064 having a density of 0.964 g/cm3 (ASTM D792-13) and an MFI of 8.0 g/10 min (ASTM D1238-13, 2.16 kg, 190° C.).

Tafmer D605 is an ethylene based elastomer, commercially available from Mitsui Chemicals, having a density of 0.861 g/cm3 (ASTM D792-13), an MFI of 0.5 g/10 min (ASTM D1238-13, 2.16 kg, 190° C.) and a shore A hardness of 58 (ASTM D2240-15).

Engage 8200 is a polyolefin elastomer commercially available from Dow, having a density of 0.870 g/cm3 (ASTM D792-13), an MFI of 5.0 g/10 min (ASTM D1238-13, 2.16 kg, 230° C.) and a shore A hardness of 66 (ASTM D2240-15).

Luzenac HAR T84 is a high aspect ratio talc commercially available from Imerys Talc. The mean particle size of talc (D50) of Luzenac HAR T84 is 2 micron as measured according to sedimentation analysis, Stockes' law (ISO 13317-3:2001).

Talc HTPultra 5c is an untrafine talc commercially available from IMI FABIC. The mean particle size of talc (D50) of Talc HTPultra 5c is 0.65 μm as measured according to sedimentation analysis, Stockes' law (ISO 13317-3:2001).

Additive package consist of 50 wt % color masterbatch, 20 wt % heat and process stabilizers, 10 wt % UV stabilizer, 20 wt % processing aid based on the total amount of the additive package.

Sample Preparation

Compounding

Pellets of Examples were prepared by compounding the components in Table 3 in a KraussMaffei Berstorff ZE40A_UTX 43D twin-screw extruder with the following setting: 400 rpm screw speed, 150 kg/h through put, 38% torque, 235° C. as temperature and 13 bar as head pressure.

Specimens Preparation

Specimens for the measurement were prepared by injection molding. The dimensions of the specimens used in tensile test are defined in ISO 527-2 type 1(a); The dimensions of the specimens used in impact resistance test are defined in ISO180/1A; The dimensions of the specimens used in warpage measurement are 65*65*3.2 mm.

Measurement Method

Melt Flow Index

Melt flow index (MFI) was measured according to ISO1133-1:2011 at 230° C. with a 2.16 kg load.

Weight percentage of the xylene-soluble part (CXS) and weight percentage of the xylene-insoluble part (CXI)

Weight percentage of the xylene-soluble part (CXS) of the heterophasic propylene copolymers was determined according to ISO16152:2005. Weight percentage of xylene-insoluble part (CXI) of the heterophasic propylene copolymers can be calculated using the following equation:

CXI=100 wt %−CXS

Both xylene-soluble and xylene-insoluble parts (CXS and CXI) obtained in this test were used in the intrinsic viscosity (IV) test.

Intrinsic Viscosity (IV)

Intrinsic viscosity (IV) of CXS and CXI was determined according to ISO1628-1:2009 and ISO1628-3:2010 respectively in decalin at 135° C.

Impact Resistance

Impact resistance is determined according to Izod ISO180:2000 at 23° C.

Tensile Modulus

Tensile modulus was determined according to ISO527-1:2012 at 23° C.

Warpage

Warpage is measured according to ISO294-4:2018 at 23° C.

Result

TABLE 2
Properties of heterophasic propylene copolymers

| | | | | | Amount of | | | | |
|---|---|---|---|---|---|---|---|---|---|
| | | | MFI before | Amount of | ethylene in the | | IV | | IV |
| | | MFI | shifting | dispersed | dispersed phase | cxs | cxs | CXI | CXI |
| | Shifted | (dg/min) | (dg/min) | phase (wt%) | (wt%) | (wt%) | (dl/g) | (wt%) | (dl/g) |
| Polymer A | No | 40 | | 20 | 60 | 17.5 | 2.2 | 82.5 | 1.25 |
| Polymer B | No | 14 | | 26 | 44 | 21.5 | 4 | 78.5 | 1.4 |
| Polymer C | Yes | 60 | 12 | 24 | 48 | 21.9 | 1.85 | 78.1 | 1.25 |

TABLE 3
Formulations and properties of polymer compositions

| | IE1 | IE2 | IE3 | CE1 | CE2 | CE3 | CE4 |
|---|---|---|---|---|---|---|---|
| Polymer A (wt%) | | 39.25 | 15 | 64.75 | | | 40.75 |
| Polymer B (wt%) | 51.35 | 15 | 38.25 | 15 | 56.35 | | 15 |
| Polymer C (wt%) | 30 | 15 | 15 | | 30 | 76.25 | 15 |
| HDPE 80064 (wt%) | 5 | 5 | 5 | 7 | | 3 | |
| DF605 (wt%) | | | | 5 | | | |
| Engage 8200 (wt%) | 5 | 7 | 7 | | 5 | 7 | 9 |
| Ultra fine talc (wt%) | | 16 | 16 | | | | 16 |
| HAR talc (wt%) | 6 | | | 5 | 6 | 11 | |
| Additive package (wt%) | 2.65 | 2.75 | 3.75 | 3.25 | 2.65 | 2.75 | 4.25 |
| Impact resistance (KJ/m2) | 48.5 | 30.4 | 27.9 | 10.4 | 13.4 | 17.0 | 13.3 |
| MFI (dg/min) | 16.2 | 22.7 | 22.3 | 22.6 | 17.1 | 32.7 | 21.5 |
| Stiffness (tensile) | 1190 | 1547 | 1698 | 1267 | 1276 | 1201 | 1543 |
| Warpage (%) | 1.052 | 1.018 | 1.067 | 1.185 | 1.075 | 1.038 | 1.062 |
| | 8 | 5 | 1 | 5 | 6 | 4 | 9 |
| Impact resistance/warpage | 4611 | 2985 | 2615 | 882 | 1250 | 1639 | 1251 |
| (KJ/m2) | | | | | | | |
| Sum Polymer C+HDPE (wt%) | 35 | 20 | 20 | 7 | 30 | 79.25 | 15 |

According to the result in Table 3, it is clear that the examples according to the invention have excellent impact resistance and good balance between impact resistance and warpage and suitable to be used as an automotive part.

1. A polymer composition comprising a first heterophasic propylene copolymer, a high density polyethylene, a second heterophasic propylene copolymer, an inorganic filler and optionally a polyolefin based elastomer,
wherein a melt flow index of the polymer composition is in a range from 5 to 100 dg/min as measured according to ISO1133-1:2011 with a 2.16 kg load at 230° C.,
wherein an amount of the first heterophasic propylene copolymer is in a range from 9.6 to 66.5 wt % based on a total amount of the polymer composition, wherein the melt flow index of the first heterophasic propylene copolymer is in a range from 29 to 103 dg/min as measured according to ISO1133-1:2011 with a 2.16 kg load at 230° C., wherein an xylene soluble part of the first heterophasic propylene copolymer is in a range from 12.9 to 27.8 wt % based on a total amount of the first heterophasic propylene copolymer as measured according to ISO16152:2005, wherein an intrinsic viscosity of the xylene soluble part of the first heterophasic propylene copolymer is in a range from 1.53 to 1.89 dl/g as measured according to ISO1628-3:2010,
wherein an amount of the high density polypropylene is in the range from 0.7 to 10.4 wt % based on the total amount of the polymer composition,
wherein an amount of the second heterophasic propylene copolymer is in a range from 12.3 to 62.5 wt % based on the total amount of the polymer composition, wherein a melt flow index of the second heterophasic propylene copolymer is in a range from 9.3 to 89.3 dg/min as measured according to ISO1133-1:2011 with a 2.16 kg load at 230° C., and
wherein an amount of the inorganic filler is in a range from 2.5 to 31.0 wt % based on the total amount of the polymer composition.

2. The polymer composition according to claim 1, wherein a total amount of the first heterophasic polypropylene and the high density polyethylene is in the range from 19.5 to 71.0 wt %, based on the total amount of the polymer composition.

3. The polymer composition according to claim 1, wherein the melt flow index of the first heterophasic propylene copolymer is in the range from 41 to 92 dg/min, as measured according to ISO1133-1:2011 with a 2.16 kg load at 230° C.

4. The polymer composition according to claim 1, wherein the amount of the first heterophasic propylene copolymer is in the range from 12.3 to 66.5 wt %, based on the total amount of the polymer composition.

5. The polymer composition according to claim 1, wherein the first propylene polymer is a propylene homopolymer or/and an ethylene-propylene copolymer wherein an amount of a moiety derived from ethylene is in the range from 0.3 to 3.9 wt % based on the total amount of the ethylene-propylene copolymer.

6. The polymer composition according to claim 1, wherein the melt flow index of the high density polyethylene is in the range from 2.3 to 19.8 dg/min, as measured according to ASTM D1238-13 with a 2.16 kg load at 190° C.

7. The polymer composition according to claim 1, wherein a density of the high density polyethylene is in the range from 0.920 to 0.972 g/cm³, as measured according to ASTM D792-13.

8. The polymer composition according to claim 1, wherein the polymer composition comprises the polyolefin based elastomer, and the polyolefin based elastomer is an ethylene-α-olefin copolymer wherein the α-olefin has 3 to 20 carbon atoms.

9. The polymer composition according to claim 1, wherein the polymer composition comprises the polyolefin based elastomer, and a melt flow index of the polyolefin based elastomer is in a range from 0.2 to 20.0 dg/min, as measured according to ASTM D1238-13 with a 2.16 kg load at 190° C.

10. The polymer composition according to claim 1, wherein the polymer composition comprises the polyolefin based elastomer, and a density of the polyolefin based elastomer is in a range from 0.853 to 0.905 g/cm³, preferably from 0.859 to 0.896 g/cm³, more preferably from 0.860 to 0.882 g/cm³, as measured according to ASTM D792-13.

11. The polymer composition according to claim 1, wherein the melt flow index of the polymer composition is in the range from 10 to 70 dg/min, as measure according to ISO1133-1:2011 with a 2.16 kg load at 230° C.

12. A process for the preparation of an article comprising the sequential steps of:
providing the polymer composition of claim 1; and
shaping the polymer composition into the article.

13. The process according to claim 12 wherein the article is an automotive part.

14. (canceled)
